(19) United States
(12) Patent Application Publication
(10) Pub. No.: US 2009/0185196 A1
(43) Pub. Date: Jul. 23, 2009

(54) GAP SENSOR ENABLING MOUNTING OF SYRINGE AND DISPENSER HAVING THE SAME

(76) Inventors: Kyu Yong Bang, Paju-si (KR); Jong Sang Kim, Paju-si (KR)

Correspondence Address: KED & ASSOCIATES, LLP, P.O. Box 221200, Chantilly, VA, 20153-1200, US

(21) Appl. No.: 12/352,079

(22) Filed: Jan. 12, 2009

(30) Foreign Application Priority Data
Jan. 22, 2008 (KR) 10-2008-0006830

(51) Int. Cl. G01B 11/14

(52) U.S. Cl. 356/625

(57) ABSTRACT

Disclosed herein is a gap sensor enabling the mounting of a syringe. The gap sensor includes an emitting part and a receiving part for measuring a distance to a substrate. A syringe mounting unit is integrally provided between the receiving part and the emitting part, so that the lower end of the syringe is inserted into and secured to the syringe mounting unit. The syringe mounting unit includes a mounting hole which holds the syringe to keep a distance between a laser beam spot formed by the emitting part and the receiving part and an outlet of the syringe constant, when the syringe is inserted into and secured to the syringe mounting unit. The syringe is directly inserted into the gap sensor to be secured thereto, thus enabling the convenient replacement of the syringe, and minimizing an error between the sensor and the outlet of the syringe which may occur during the replacement of the syringe, therefore allowing the syringe to be more precisely mounted.

### BACKGROUND OF THE INVENTION

1. Field of the Invention

The present invention relates generally to a dispenser for dispensing a liquid crystal or sealant to a glass substrate of a liquid crystal display (LCD) and, more particularly, to a gap sensor constructed so that a syringe is directly inserted into and precisely mounted on the gap sensor and a dispenser having the gap sensor.

2. Description of the Related Art

The LCD which is one of flat panel displays (FPDs) is generally manufactured by adhering a glass substrate having a plurality of pixel patterns thereon to a glass substrate having a color filter layer thereon. Further, a liquid crystal layer is formed between the two glass substrates, with outer edges sealed by a sealant.

In order to manufacture the LCD, the process of dispensing a liquid crystal or sealant on the glass substrate is required. For the dispensing process, a dispenser is used.

Generally, the dispenser includes a stage on which a substrate is mounted, a dispenser head having a nozzle to dispense a liquid crystal or sealant to the substrate, and a head support to which the dispenser head is mounted. The dispenser is constructed to dispense the liquid crystal or sealant on the substrate while changing a relative position between the substrate and the nozzle.

Particularly, the dispenser head is provided with a syringe which stores the liquid crystal or sealant, and the nozzle is installed at an end of the syringe, so that the liquid crystal or sealant is dispensed on the substrate in a desired pattern.

In order to enhance the quality and productivity of the LCD, the liquid crystal or sealant must be dispensed to the glass substrate at a desired level of precision and the efficiency and productivity of the dispensing process must be increased. For these reasons, a dispenser having superior performance has been variously developed.

The inventor of the present invention continues research and development so as to improve the performance of the dispenser. As the result of the research and development, ‘Apparatus for Detachably Holding Syringe of Paste Dispenser’ and ‘Sealant Dispenser’ were filed and patented, which are disclosed in Korean Patent Nos. 10-696935 and 10-710683, respectively.

The above patents considerably improved the performance of the dispenser. However, the inventor of the present invention has developed technology related to a dispenser which has superior dispensing precision and increases the efficiency of a process, so that the inventor intends to file the present invention obtained as the result of the research and development for a patent.

Prior to the description of the present invention, the patented inventions of the inventor will be described below in brief, and additional requirements for each invention will be also described.

First, Korean patent No. 10-696935 (hereinafter, referred to as patented invention 1) will be described with reference to FIGS. 1 and 2.

FIG. 1 is a perspective view illustrating the mounted state of a syringe in the patented invention 1, and FIG. 2 is a perspective view illustrating the important parts of a syringe holding apparatus, in the patented invention 1.

According to the patented invention 1, the syringe holding apparatus is provided with a toggle clamp 25, thus allowing a syringe 10 to be locked or released simply by manipulating a lever 27. This reduces the time and efforts which are required to replace the syringe 10, and omits a plurality of fastening bolts unlike the conventional syringe holding apparatus, thus minimizing the generation of dust, therefore minimizing the ingress of impurities during a liquid crystal dispensing process.

In the drawing, reference numeral 18 denotes a support bracket for supporting the toggle clamp 25.

The syringe 10 includes a cylindrical storage container 12, and a nozzle holder 14 which is provided under the storage container 12 and provided with a nozzle to discharge a liquid crystal or sealant.

Further, a support block 20 is mounted to a head block 16 to support and lock the syringe 10. That is, as shown in FIG. 2, an insert hole 22 is formed in the support block 20, so that the nozzle holder 14 of the syringe 10 is inserted into the insert hole 22, as shown in FIG. 1. Here, the toggle clamp 25 functions to hold the nozzle holder 14 firmly.

Meanwhile, a gap sensor (not shown) having an emitting part and a receiving part on both sides of the support block 20 is installed to measure a gap between a substrate and a nozzle.

However, the patented invention 1 is problematic in that the support block 20 for supporting the nozzle holder 14 and the gap sensor for measuring the gap between the nozzle and the substrate are separated from each other and individually installed to the head block 16, so that it is difficult to more precisely measure the gap between the nozzle and the substrate, and thus the position of the nozzle must be frequently corrected.

That is, the nozzle and the gap sensor are coupled to each other via another structure. Thus, when an assembly error is made between assembly parts or the coupling between the parts is loosened, the re-setting of the parts is required.

As such, the part (support block) to which the nozzle is mounted and the gap sensor are separated from each other. Moreover, the support block 20 has no mounting structure so as to keep the interval between the laser beam spot of the gap sensor and the outlet of the nozzle constant. Thus, in the case of replacing the syringe 10 with another one, the laser beam spot of the gap sensor and the nozzle outlet deviate frequently from the original positions. In this case, while the position of the syringe is adjusted manually, the relative position between the nozzle and the sensor must be re-adjusted, thus inconveniencing a user.

Further, the patented invention 1 is problematic in that only the lower portion of the nozzle holder 14 is inserted into and secured to the support block 20, so that an additional support device (see FIG. 1) for supporting the storage container 12 is required, and thus the entire syringe mounting structure becomes complicated.

Next, Korean patent No. 10-710683 (hereinafter, referred to as ‘patented invention 2’) will be described with reference to FIG. 3.

FIG. 3 is a view disclosed in the publication of the patented invention 2, and illustrates the construction of a sealant dispenser.

The sealant dispenser of the patented invention 2 is constructed so that an injector, namely, a syringe 10′ is coaxial with a nozzle 14′, thus lowering the discharge pressure of a sealant discharged from the nozzle 14′, more precisely detecting a gap between a substrate and the nozzle 14′, and correcting the position of the nozzle 14′ to keep a distance between the nozzle 14′ and a gap sensor 30 constant when the syringe 10′ is replaced with another one, therefore allowing the sealant to be more precisely dispensed to the substrate.

The patented invention 2 is advantageous in that it enables the sealant to be very precisely dispensed. However, the patented invention 2 is problematic in that the syringe 10′ and the gap sensor 30 are separately installed or supported, as in the patented invention 1, so that it is difficult to consistently maintain the precise position of the nozzle 14′ relative to the gap sensor 30.

That is, the sealant dispenser of the patented invention 2 is constructed so that an emitting part 31 and a receiving part 32 constituting the gap sensor 30 are integrated into a single body, a coupling hole 33 is formed between the emitting part 31 and the receiving part 32, and the lower portion of the syringe 10′ is inserted into the coupling hole 33. But, as shown in the drawing, a tip of the nozzle 141 is simply inserted into and passes through the coupling hole 33 of the gap sensor 30. Substantially, while the syringe 10′ and the nozzle 141 coupled to the syringe 10′ are supported by an additional adjusting part 40, the positions of the syringe 10′ and the nozzle 14′ may be adjusted by the adjusting part 40.

The patented invention 2 is constructed so that the tip of the nozzle 14′ simply passes through the coupling hole 33 of the gap sensor 30, and the syringe 10′ is assembled with the adjusting part 40 to be supported by the adjusting part 40. Thus, the patented invention 2 is problematic in that the positions of the laser beam spot of the gap sensor 30 and the outlet of the nozzle 14′ are changed whenever the syringe 10′ is replaced with another one, as in the above-mentioned patented invention 1, so that the position of the syringe 10, must be manually adjusted by the adjusting part 40, thus inconveniencing a user.

As a result, the patented invention 1 and 2 are problematic in that the structure for supporting the syringe and the gap sensor are separately constructed and assembled with a head block or the like, so that the entire syringe mounting structure becomes complicated, and it is required to precisely correct the relative position between the gap sensor and the nozzle whenever the syringe is replaced with another one.

### SUMMARY OF THE INVENTION

Accordingly, the present invention has been made keeping in mind the above problems occurring in the prior art, and an object of the present invention is to provide a gap sensor enabling the mounting of a syringe and a dispenser having the gap sensor, in which the syringe is directly mounted and secured to the gap sensor, thus allowing the syringe to be conveniently replaced with another one merely by single syringe insertion or separation work.

Another object of the present invention is to provide a gap sensor enabling the mounting of a syringe and a dispenser having the gap sensor, in which the lower portion of the syringe is accurately mounted at a precise position on the gap sensor, thus allowing the syringe to be always mounted at a precise position only by single mounting work without the necessity of additionally correcting a distance between the laser beam spot of the sensor and the outlet of a nozzle when the syringe is replaced with another one.

A further object of the present invention is to provide a gap sensor enabling the mounting of a syringe and a dispenser having the gap sensor, in which even the upper portion of a nozzle coupled to the syringe is supported by the gap sensor, thus allowing the syringe to be stably supported only by the gap sensor even if there is no additional support structure.

In order to accomplish the above objects, the present invention provides a gap sensor enabling the mounting of a syringe, including an emitting part and a receiving part for measuring a distance to a substrate, and a syringe mounting unit integrally provided between the receiving part and the emitting part, so that a lower end of the syringe is inserted into and secured to the syringe mounting unit. The syringe mounting unit includes a mounting hole which holds the syringe to keep a distance between a laser beam spot formed by the emitting part and the receiving part and an outlet of the syringe constant, when the syringe is inserted into and secured to the syringe mounting unit.

When the syringe includes a storage container for storing substance to be dispensed to the substrate, and a nozzle holder which is equipped with a nozzle, is coupled to a lower portion of the storage container and has on an end thereof an outlet of the syringe, the mounting hole of the syringe mounting unit is formed such that the nozzle holder is inserted into and secured to the mounting hole.

The mounting hole is formed to support a portion extending from a lower portion of the nozzle holder to an upper portion thereof, thus stably holding the syringe.

Further, the mounting hole is formed to have the same shape as that of the nozzle holder, thus maintaining a stable mounted state when the nozzle holder is inserted into the mounting hole. Each of the mounting hole and the nozzle holder is formed to have a multi-stepped structure. When the nozzle holder is formed in the multi-stepped structure such that the outer diameter of the nozzle holder is reduced in stages in a direction from an upper position to a lower position, the mounting hole is formed such that the inner diameter thereof is reduced in stages to correspond to the outer diameter of the nozzle holder.

The uppermost coupling part of the mounting hole to which the nozzle holder is coupled is formed to have a polygonal structure, thus preventing the coupled nozzle holder from rotating.

The uppermost coupling part of the mounting hole to which the nozzle holder is coupled is open in one surface thereof, thus allowing the coupled state of the nozzle holder to be observed.

Meanwhile, the receiving part, the emitting part, and the syringe mounting unit are separately constructed and assembled into a single structure.

The gap sensor further includes a syringe holding unit which is provided on the gap sensor and functions to additionally hold the syringe inserted into the mounting hole using external force.

The syringe holding unit includes a toggle clamp, and a locking bar operated by the toggle clamp and locking the nozzle.

Further, in order to accomplish the above objects, the present invention provides a dispenser having a gap sensor enabling the mounting of a syringe, including a stage on which a substrate is mounted, a dispenser head movably installed above the stage, a gap sensor constructed as described above and supported by the dispenser head, and a syringe mounted on a syringe mounting unit of the gap sensor and providing substance to be dispensed to the substrate.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are views disclosed in Korean Patent No. 10-696935, in which FIG. 1 is a perspective view illustrating a conventional mounted state of a syringe, and FIG. 2 is a perspective view illustrating important parts of a syringe holding unit;

FIG. 3 is a view illustrating the construction of a sealant dispenser disclosed in Korean Patent No. 10-710683;

FIG. 4 is a perspective view illustrating a dispenser head having a gap sensor according to the present invention;

FIG. 5 is an exploded perspective view illustrating the state in which a syringe is being mounted on the gap sensor according to the present invention;

FIG. 6 is a perspective view illustrating the coupled state of the syringe with the gap sensor according to the present invention;

FIG. 7 is a perspective view illustrating the coupled state of the syringe with the gap sensor according to the present invention, when viewing the syringe coupled with the gap sensor in a different direction;

FIG. 8 is a front view illustrating the coupled state of the syringe with the gap sensor according to the present invention;

FIG. 9 is a sectional view illustrating the coupled state of the syringe with the gap sensor according to the present invention;

FIG. 10 is a perspective view illustrating the state in which a syringe holding unit is installed to the gap sensor according to the present invention;

FIG. 11 is a vertical sectional view of FIG. 10; and

FIG. 12 is a perspective view illustrating the construction of a gap sensor according to another embodiment of the present invention.

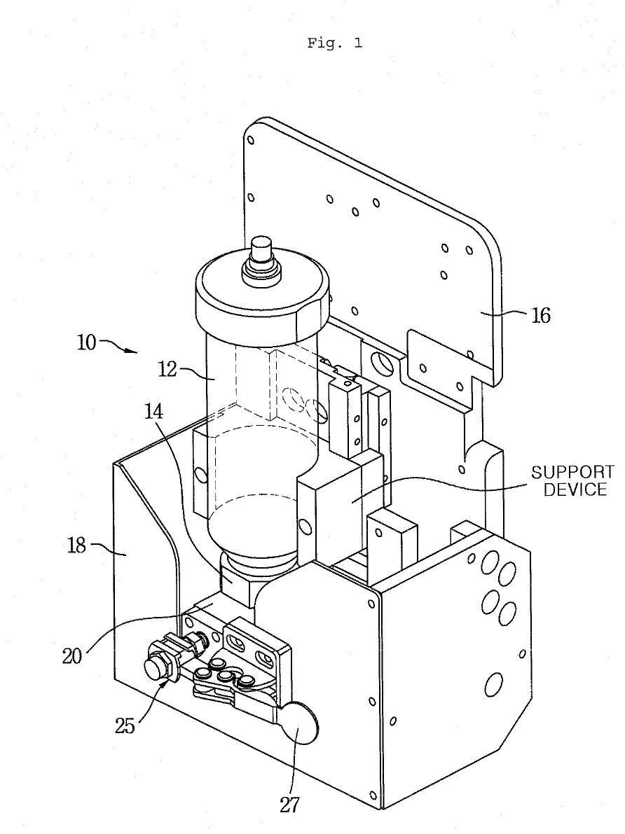

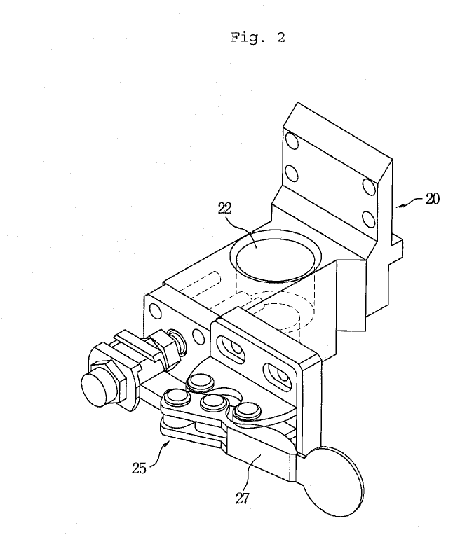

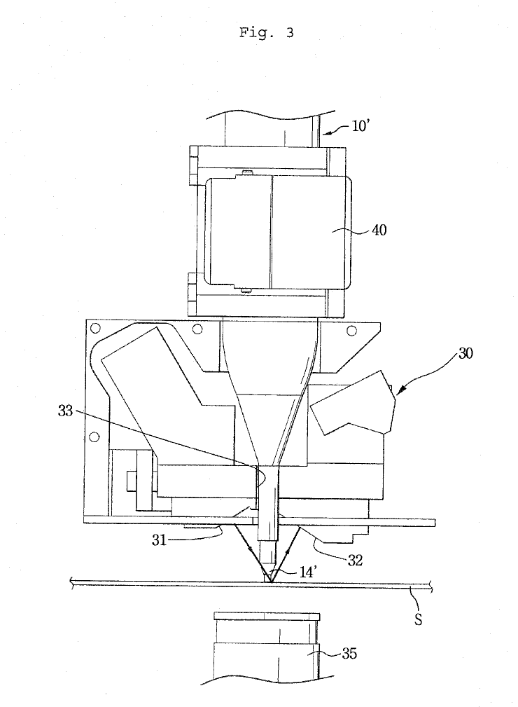

### DESCRIPTION OF THE PREFERRED EMBODIMENTS

The preferred embodiments of the present invention will be described with reference to the accompanying drawings.

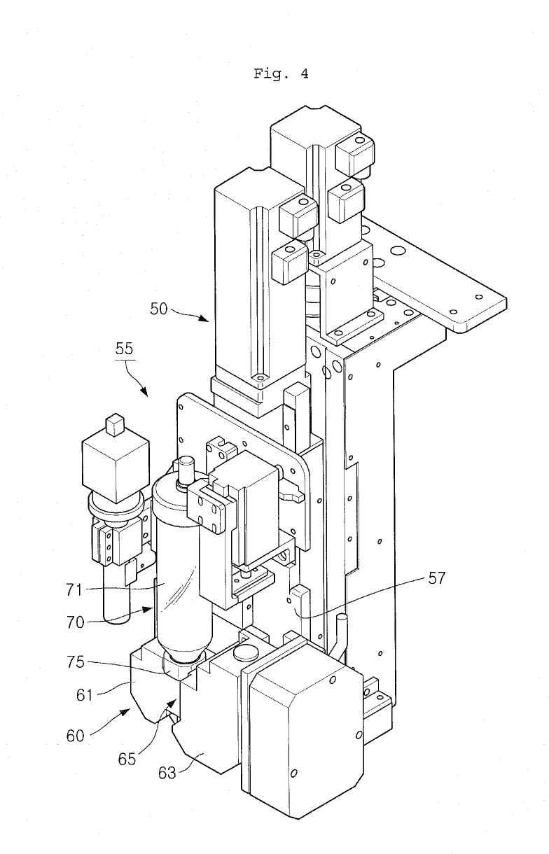

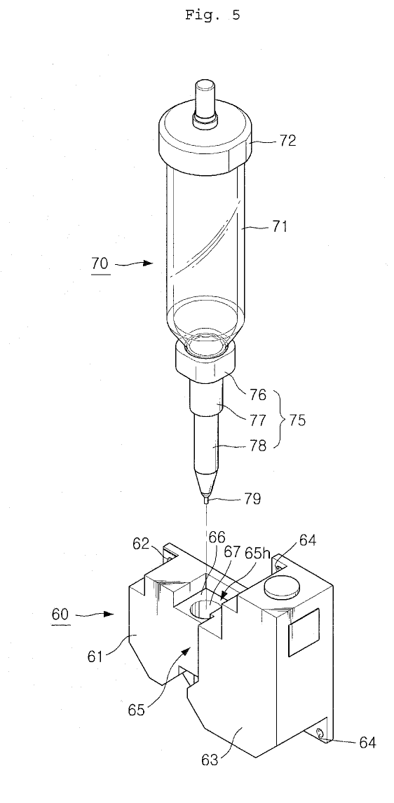

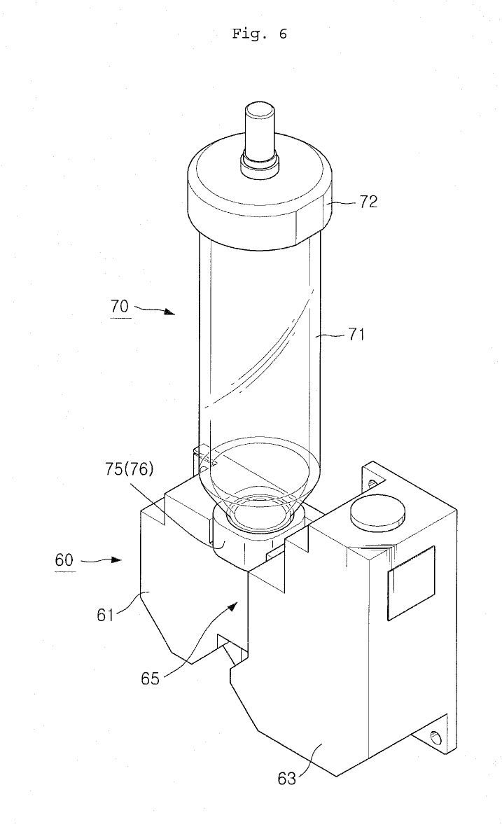

FIGS. 4 to 9 are views illustrating a gap sensor according to one embodiment of the present invention. Here, FIG. 4 is a perspective view illustrating a dispenser head including the gap sensor, and FIGS. 5, 6, 7, 8, and 9 are an exploded perspective view, a perspective view, a perspective view when seen from another direction, a front view and a sectional view, respectively, illustrating the state in which a syringe is mounted on the gap sensor.

First, the dispenser having the gap sensor according to the present invention will be described with reference to FIG. 4.

In the dispenser, a dispenser head 55 is coupled to a vertical transfer mechanism 50, so that the dispenser head 55 is movable in a vertical direction by the operation of the vertical transfer mechanism 50. As such, by moving the dispenser head 55 in the vertical direction using the vertical transfer mechanism 50, a gap between a nozzle 79 mounted on the dispenser head 55 and a substrate placed on a stage (not shown) is adjusted.

A head plate 57 is provided on the dispenser head 55, and comprises a vertical plate which is coupled to the vertical transfer mechanism 50 and moved up and down. The gap sensor 60 is installed in front of the head plate 57 and measures a distance between the substrate and the nozzle 79.

Further, the dispenser head 55 is constructed so that the syringe 70 for dispensing a liquid crystal or sealant to the substrate is mounted on the dispenser head 55. The syringe mounting structure of the present invention is constructed so that the syringe 70 is directly inserted into the gap sensor 60 to be precisely mounted thereto without an additional support structure, unlike the conventional syringe mounting structure.

The gap sensor enabling the mounting of the syringe according to the present invention will be described with reference to FIGS. 5 to 9.

First, the gap sensor 60 is a device which measures the distance between the substrate and the nozzle 79 and allows the liquid crystal or sealant to be dispensed to the substrate while the gap between the nozzle 79 and the substrate is kept constant. Such a gap sensor 60 may comprise various kinds of sensors for measuring a distance. However, as one example of the present invention, a laser gap sensor using laser beams will be described herein.

The laser gap sensor 60 includes an emitting part 61 which emits laser beams to the substrate, and a receiving part 63 which is opposite to the emitting part 61 and receives laser beams reflected from the substrate to measure a distance between the substrate and the nozzle.

Since the basic principle of the distance measurement of the laser gap sensor 60 is known to those skilled in the art, it will be omitted herein. The laser gap sensor 60 used in the present invention is constructed so that the emitting part 61 and the receiving part 63 are provided on opposite sides of the nozzle 79, thus measuring a distance from the sensor 60 to the substrate.

Particularly, the laser gap sensor 60 of the present invention is provided with a syringe mounting unit 65 which allows the syringe 70 equipped with a nozzle holder 75 to be directly inserted and mounted to the laser gap sensor 60. Preferably, the syringe mounting unit 65 is positioned between the emitting part 61 and the receiving part 63. Thus, the syringe mounting unit 65, the emitting part 61 and the receiving part 63 are integrated into a single body, thus constituting the laser gap sensor 60.

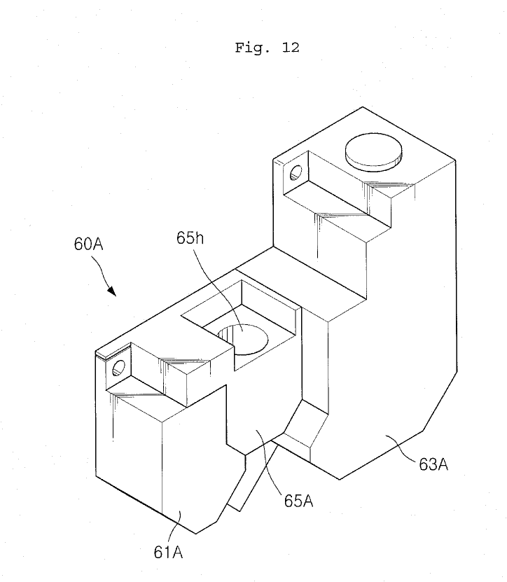

Preferably, the important parts of the laser gap sensor 60 are integrally provided in one casing. However, without being limited to the construction, blocks forming respective parts may be integrally coupled to each other. The construction will be described later with reference to FIG. 12. Herein below, the embodiment wherein the important parts of the laser gap sensor 60 are integrated into a single structure will be described.

The emitting part 61 and the receiving part 63 may include therein the means which emit and receive laser beams and transform a distance measuring result into a signal to output it. Screw holes 62 and 64 (see FIG. 5) are formed in the outer portions of the emitting part 61 and the receiving part 63 so that they are screwed to the head plate 57 of FIG. 4.

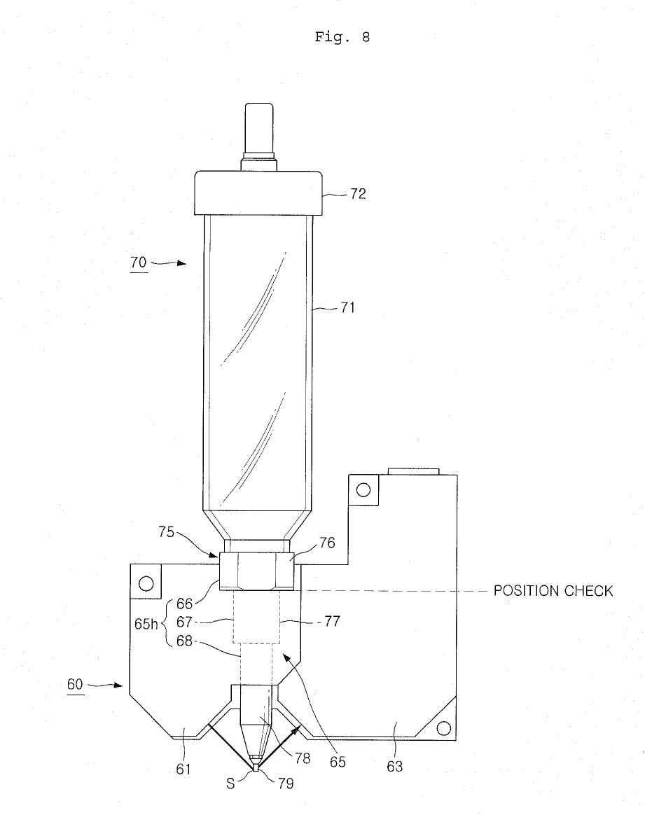

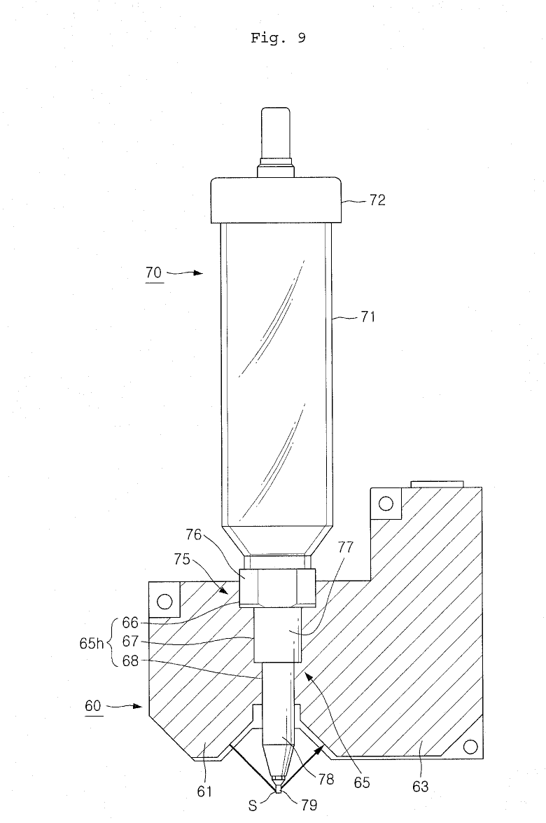

Particularly, a mounting hole 65h is formed in the syringe mounting unit 65 so that the nozzle holder 75 coupled to the syringe 70 is inserted into and mounted to the syringe mounting unit 65. When the nozzle holder 75 of the syringe 70 is inserted into the mounting hole 65h to be secured thereto, the mounting hole 65h supports the syringe 70 such that the distance between the laser beam spot S formed by the emitting part 61 and the receiving part 63 and the tip of the nozzle 79, as shown in FIGS. 8 and 9, is kept constant.

Such a mounting hole 65h is formed to have a plurality of steps, the inner diameters of which are reduced in stages in a direction from an upper position to a lower position, thus allowing the nozzle holder 75 coupled to the syringe 70 to be inserted into the mounting hole 65h from the upper portion thereof and thus directly mounted to the mounting hole 65h.

That is, referring to FIG. 9, the mounting hole 65h has in an upper portion a first mounting part 66 to which the upper end of the nozzle holder 75 is coupled. Under the first mounting part 66 is formed a second mounting part 67 which has a relatively smaller diameter than that of the first mounting part 66. Similarly, under the second mounting part 67 is formed a third mounting part 68 which has a relatively smaller diameter than that of the second mounting part 67.

According to this embodiment, the mounting hole 65h includes three mounting parts 66, 67 and 68. Of course, the mounting hole may include two mounting parts or four or more mounting parts, according to the required condition.

Here, it is necessary that the mounting hole 65h be formed in the syringe mounting unit 65 to sufficiently support a portion of the nozzle holder 75 extending from the lower end thereof to the upper end. Such a support structure will be described below again.

Next, the syringe 70 which is directly inserted into and mounted to the syringe mounting unit 65 of the laser gap sensor 60 constructed as described above will be described.

The syringe 70 includes a barrel-shaped storage container 71 which stores the liquid crystal or sealant therein, and the nozzle holder 75 which is coupled to the lower portion of the storage container 71 and provided with the nozzle 79 for discharging the liquid crystal or sealant to the substrate.

A cap 72 is mounted to the upper end of the storage container 71 to close the upper end of the syringe 70.

The nozzle holder 75 is constructed to be inserted into and stably coupled to the syringe mounting unit 65. As shown in the drawings, when the syringe mounting unit 65 is a three-stepped structure having the mounting parts 66, 67 and 68, it is preferable that the nozzle holder 75 also have a three-stepped structure.

Such a construction will be described with reference to FIGS. 5 and 9. That is, a through hole (not shown) is formed in the central portion of the nozzle holder 75 to permit dispensing substance including the liquid crystal or sealant to pass, and the nozzle 79 constituting the outlet of the syringe 70 is mounted to the end of the nozzle holder 75.

In order to mount the nozzle holder 75 to the syringe mounting unit 65 of the gap sensor 60, a first coupling part 76, a second coupling part 77, and a third coupling part 78 are continuously formed sequentially from the upper portion of the nozzle holder 75 to the lower portion thereof. The outer diameter of the nozzle holder 75 is gradually reduced in a direction from the first coupling part 76 to the third coupling part 78.

Here, the first coupling part 76 is coupled to the storage container 71 and preferably has an internal threaded portion therein to be fastened to the storage container 71 in a threaded manner. Further, the nozzle 79 for discharging the liquid crystal or sealant is mounted to the end of the third coupling part 78 in such a way as to protrude outwards.

Further, the nozzle holder 75 may comprise a single body. However, the first coupling part 76, or the first and second coupling parts 76 and 77 may form the nozzle holder, while the third coupling part 78 may form a nozzle pipe which is inserted into the first coupling part 76 or the second coupling part 77.

Now, the syringe mounting unit 65 of the gap sensor 60 and the coupling parts of the nozzle holder 75 having the above construction will be described with regard to corresponding structures.

In the present invention, the syringe mounting unit 65 is constructed so that the syringe 70 is mounted and the position of the nozzle 79 is determined merely by inserting the syringe 70 into the syringe mounting unit 65 without an additional mounting (support) unit. The syringe mounting unit 65 has a multi-stepped structure so that the nozzle holder 75 is secured at a precise position on the gap sensor 60 and a stable mounted state is maintained.

Particularly, the first mounting part 66 of the syringe mounting unit 65 is constructed to support the first coupling part 76 which is the upper end of the nozzle holder 75. Such a construction can more stably support the syringe 70 to which the nozzle holder 75 is coupled.

The coupling structure of the first mounting part 66 with the first coupling part 76 may be variously formed. According to this embodiment, a rectangular coupling structure is provided, as shown in the drawings, so as to prevent the rotation of the syringe 70 in the state where it is mounted.

That is, the first coupling part 76 of the nozzle holder 75 has a rectangular cross-section, and the first mounting part 66 of the gap sensor 60 to which the rectangular first coupling part 76 is mounted also has a rectangular cavity which is open at the front.

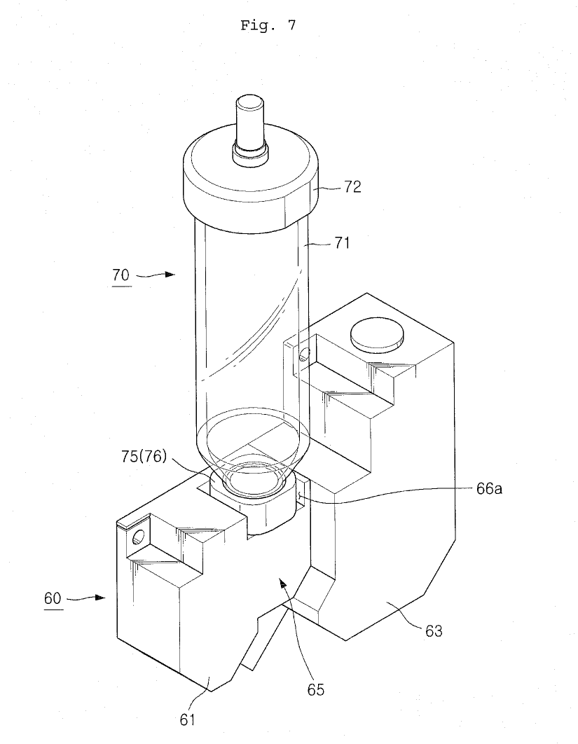

Referring to FIG. 7, the opening 66a of the first mounting part 66 allows a person to precisely see the mounted position of the nozzle holder 75. That is, in order to stably mount the nozzle holder 75 to the mounting hole 65h without shaking, the outer diameter of the nozzle holder 75 must be almost equal to the inner diameter of the mounting hole 65h so that the nozzle holder 75 is fitted into the mounting hole 65h through force-fitting. Thus, in the case where the first mounting part 66 is formed to have the structure of a cavity which is not open, it is difficult to check whether the nozzle holder 75 has been completely inserted into the mounting hole 65h. However, when the bottom of the first coupling part 76 of the nozzle holder 75 is in complete close contact with the bottom of the first mounting part 66, as shown in FIG. 8, it is determined that the nozzle holder 75 is inserted into a precise position. This can be conveniently observed through the opening 66a which is formed in the front of the first mounting part 66.

Unlike the coupling structure of the first mounting part 66 with the first coupling part 76, the second mounting part 67 and the second coupling part 77, and the third mounting part 68 and the third coupling part 78 preferably have cylindrical structures. Of course, they may have inclined tapered structures in place of the cylindrical structures. Further, they may have rectangular structures, as in the first mounting part 66 and the first coupling part 76.

Meanwhile, according to the above embodiment, the coupling structure of the syringe mounting unit 65 with the nozzle holder 75 is formed to be reduced in stages. However, if the inner diameter of the mounting hole 65h and the outer diameter of the nozzle holder 75 are formed to be equal to each other such that the precise fitting of the nozzle holder 75 with the mounting hole 65h is possible, the syringe mounting unit 65 and the nozzle holder 75 may have tapered structures in such a way that the inner diameter of the syringe mounting unit 65 and the outer diameter of the nozzle holder 75 are gradually reduced in a direction from an upper position to a lower position, according to the required condition.

Further, a plurality of protrusions and grooves may be formed in junctions of the mounting hole 65h with the nozzle holder 75 to be coupled to each other, so that the mounting hole 65h and the nozzle holder 75 are coupled to each other at a plurality of points.

Hereinafter, gap sensors according to several modifications of the present invention will be described.

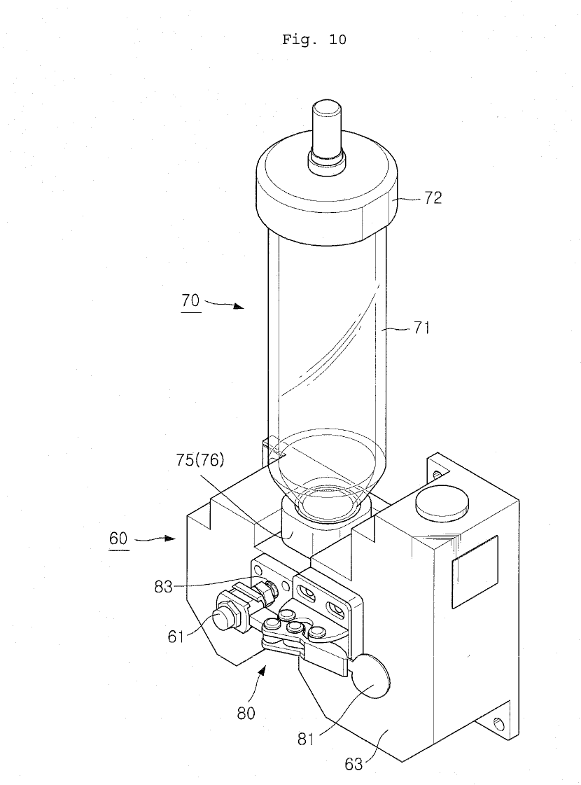

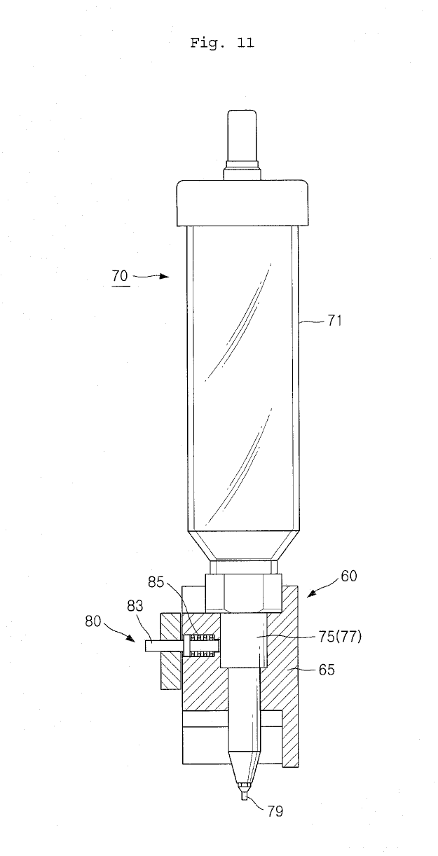

First, a gap sensor having a syringe holding unit according to a modification of the present invention will be described with reference to FIGS. 10 and 11.

FIG. 10 is a perspective view illustrating the state in which the syringe holding unit is mounted to the gap sensor according to the present invention, and FIG. 11 is a vertical sectional view of FIG. 10.

As shown in the drawings, the syringe holding unit 80 which is mounted to the gap sensor 60 to hold the syringe 70 at a predetermined position preferably uses a toggle clamp which is disclosed in Korean Patent No. 10-696935.

That is, when the lever 81 of the toggle clamp is pressed, the locking bar 83 of the syringe holding unit 80 passing through the gap sensor 60 overcomes the elastic force of a spring 85 and moves inwards. At this time, the locking bar 83 comes into close contact with the nozzle holder 75, thus locking the syringe at a predetermined position. Here, the locking bar 83 may be constructed to come into close contact with the second coupling part 77.

In contrast, when the lever 81 is pulled, the locking bar 83 is removed from the nozzle 79, so that the lock state of the nozzle holder 75 is released.

Since other constructions and operations are described in detail in Korean patent No. 10-696935, they will be omitted.

Meanwhile, the syringe holding unit may use a conventional detent structure without being limited to the above construction.

That is, a detent ball (or detent pin) is provided in the mounting hole 65h of the syringe mounting unit 65 to be ejected by a spring, and a hemispherical groove is formed in the outer surface of the nozzle holder 75 so that the detent ball is inserted into the hemispherical groove. As such, the detent ball is inserted into the groove of the nozzle, thus more reliably holding the syringe.

Next, the construction of the gap sensor which is integrally assembled will be described with reference to FIG. 12.

FIG. 12 is a perspective view illustrating the gap sensor according to another embodiment of the present invention.

According to the above-mentioned embodiment, the gap sensor is constructed to have the single body. However, if necessary, an emitting part 61A, a receiving part 63A and a syringe mounting unit 65A constituting a gap sensor 60A may have independent block structures and be integrally assembled into one set, as shown in FIG. 12.

Of course, the syringe mounting hole 65h which has been described in detail with reference to FIGS. 5 to 9 is formed in the syringe mounting unit 65A.

Since other constructions remain the same as the construction of FIGS. 5 to 9, the detailed description of the constructions will be omitted herein.

As described above, the present invention provides a gap sensor enabling the mounting of a syringe and a dispenser having the gap sensor, which have the following effects.

First, the present invention is advantageous in that a syringe mounting unit is provided to mount and hold a syringe to a gap sensor, thus allowing the syringe to be conveniently replaced with another one only with a single syringe separation or insertion operation.

Particularly, the present invention is advantageous in that a syringe is directly mounted and secured to a gap sensor, a syringe mounting hole for holding the syringe is provided to keep a distance between the laser beam spot of the sensor and the outlet (nozzle) of the syringe always constant, so that the position of the nozzle mounted to the gap sensor is always constant, thus preventing an interval between the sensor and the nozzle from being changed when the syringe is replaced with another one, therefore enabling the syringe to be always mounted to a precise position only with a single mounting operation without an additional correcting operation.

Further, the present invention is constructed so that the syringe mounting unit of a gap sensor supports even the upper portion of a nozzle coupled to a syringe, thus allowing the syringe to be stably supported only by the gap sensor without using an additional support structure, therefore affording a simple syringe mounting structure.

Furthermore, the present invention is advantageous in that portion of the syringe mounting unit of a gap sensor and portion of the coupling part of a nozzle have polygonal structures, or a syringe holding unit is installed at the gap sensor, thus preventing a syringe mounted on the gap sensor from rotating or moving in a vertical direction, therefore more stably supporting the syringe.

Further, the present invention is advantageous in that the uppermost mounting part of the syringe mounting unit of a gap sensor is open, thus allowing a person to easily check whether a syringe is precisely mounted or not.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A gap sensor enabling the mounting of a syringe, comprising:
an emitting part and a receiving part for measuring a distance to a substrate; and
a syringe mounting unit integrally provided between the receiving part and the emitting part, so that a lower end of the syringe is inserted into and secured to the syringe mounting unit, wherein the syringe mounting unit comprises a mounting hole which holds the syringe to keep a distance between a laser beam spot formed by the emitting part and the receiving part and an outlet of the syringe constant, when the syringe is inserted into and secured to the syringe mounting unit.

2. The gap sensor as set forth in claim 1, wherein, when the syringe comprises a storage container for storing substance to be dispensed to the substrate, and a nozzle holder which is equipped with a nozzle, is coupled to a lower portion of the storage container and comprises on an end thereof an outlet of the syringe, the mounting hole of the syringe mounting unit is formed such that the nozzle holder is inserted into and secured to the mounting hole.

3. The gap sensor as set forth in claim 2, wherein the mounting hole is formed to support a portion extending from a lower portion of the nozzle holder to an upper portion thereof, thus stably holding the syringe.

4. The gap sensor as set forth in claim 2, wherein the mounting hole is formed to have the same shape as that of the nozzle holder, thus maintaining a stable mounted state when the nozzle holder is inserted into the mounting hole.

5. The gap sensor as set forth in claim 4, wherein each of the mounting hole and the nozzle holder is formed to have a multi-stepped structure.

6. The gap sensor as set forth in claim 5, wherein, when the nozzle holder is formed in the multi-stepped structure such that an outer diameter of the nozzle holder is reduced in stages in a direction from an upper position to a lower position, the mounting hole is formed such that an inner diameter thereof is reduced in stages to correspond to the outer diameter of the nozzle holder.

7. The gap sensor as set forth in claim 2, wherein an uppermost coupling part of the mounting hole to which the nozzle holder is coupled is formed to have a polygonal structure, thus preventing the coupled nozzle holder from rotating.

8. The gap sensor as set forth in claim 2, wherein the uppermost coupling part of the mounting hole to which the nozzle holder is coupled is open in a first surface thereof, thus allowing the coupled state of the nozzle holder to be observed.

9. The gap sensor as set forth in claim 1, wherein the receiving part, the emitting part, and the syringe mounting unit are separately constructed and assembled into a single structure.

10. The gap sensor as set forth in claim 1, further comprising:
a syringe holding unit provided on the gap sensor, and functioning to additionally hold the syringe inserted into the mounting hole using external force.

11. The gap sensor as set forth in claim 10, wherein the syringe holding unit comprises:
a toggle clamp; and
a locking bar operated by the toggle clamp and locking the nozzle.

12. A dispenser having a gap sensor enabling the mounting of a syringe, comprising:
a stage on which a substrate is mounted;
a dispenser head movably installed above the stage;
a gap sensor described in any one of claims 1 to 11 and supported by the dispenser head; and
a syringe mounted on a syringe mounting unit of the gap sensor and providing substance to be dispensed to the substrate.
